(19) United States
(12) Patent Application Publication
(10) Pub. No.: US 2008/0202368 A1
(43) Pub. Date: Aug. 28, 2008

(54) PRINTING METHOD AND PRINTING PRESS

(75) Inventors: Fumito Kajitani, Hiroshima (JP); Shigeo Makino, Hiroshima (JP); Yukikazu Shoji, Hiroshima (JP); Yoshiaki Kanda, Hiroshima (JP); Yasunori Tanabe, Hiroshima (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 11/923,087

(22) Filed: Oct. 24, 2007

(30) Foreign Application Priority Data
Feb. 27, 2007 (JP) 2007-047420

(51) Int. Cl. B41F 31/00

(52) U.S. Cl. 101/350.1; 101/491

(57) ABSTRACT

An ink supplying unit supplies a water-based ink having a predetermined water content set in advance. An ink form roller receives the water-based ink from the ink supplying unit. A plate cylinder is in contact with the ink form roller, and receives the water-based ink from the ink form roller. A water-content decreasing unit decreases the water content of the water-based ink on the ink form roller.

### RELATED APPLICATIONS

The present application is based on, and claims priority from, Japan Application Number 2007-047420, filed Feb. 27, 2007, the disclosure of which is hereby incorporated by reference herein in its entirety.

### BACKGROUND OF THE INVENTION

1. Field of the Invention

The present invention relates to a printing method and a printing press, such as a sheet-fed offset printing press or a web offset printing press, and more particularly, to a printing unit capable of controlling a water content of an ink.

2. Description of the Related Art

A web offset printing press generally includes a feeder device, an infeed device, a printing device, a drying device, a cooling device, a web passing device, a folding device, and a delivery device. The feeder device includes a reel stand on which two web rolls, including a first web roll and a second web roll, are mounted. A web pulled out from the first web roll is connected to a web of the second web roll so that the web is fed continuously. The infeed device feeds the web to the printing device at a predetermined speed. The printing device generally includes four printing units for black, cyan, magenta, and yellow inks respectively. The printing units are arranged to be aligned along a feeding direction of the web. The drying device dries inks on the web printed by the printing device. The cooling device cools the web dried by the drying device down to an appropriate temperature because a temperature of the dried web is excessively high. The web passing device passes the cooled web to the folding device. The folding device folds and cuts the web into a predetermined size, and further folds the cut webs into a predetermined size to form folded papers. The delivery device delivers the folded papers to outside the printing press.

In this manner, a roll-like web is pulled out from the web roll by the feeder device, and fed to the printing device at the predetermined speed by the infeed device. Then, a multicolor image is printed on the web by the printing units included in the printing device. After inks on the web are dried by the drying device, the web is cooled down by the cooling device, and passed to the folding device by the web passing device. The web is formed into folded papers by the folding device, and the folded papers are delivered outside the printing press by the delivery device.

In a case of a perfecting printing press, each of the printing units includes two sets of an ink supplying device, an ink form roller, a plate cylinder, and a blanket cylinder in a symmetrical manner across the web that is fed in a horizontal direction. The ink supplying device includes an ink fountain, and transfers an ink from the ink fountain to an ink roller group via an ink fountain roller and an ink transfer roller, and finally supplies the ink to the ink form roller. The ink form roller and the plate cylinder have contact with each other, and also the plate cylinder and the blanket cylinder have contact with each other. A plate is mounted on a surface of the plate cylinder. Upon receiving the ink from the plate of the plate cylinder, the blanket cylinder transfers the ink onto the web as a printing image.

In accordance with rotations of the rollers in the ink supplying device, an appropriate amount of the ink, which is adjusted by the ink fountain roller, is supplied from the ink fountain to the ink transfer roller. The ink is moderately kneaded by the ink roller group, so that a thin film is formed on a surface of the ink. Then, the ink with the thin film is transferred from the ink form roller onto the plate surface of the plate cylinder, and further transferred onto the blanket cylinder. When the web is sandwiched between the blanket cylinders, a predetermined degree of printing pressure is applied to the web, and thus the ink on the blanket cylinder is transferred onto the web as a printing image.

The ink retained in the ink fountain is adjusted to have an optimal water rate (water content) for printing. However, even though the water content of the ink is adjusted to obtain a high transferability and a good image-forming performance of the ink, the water content varies because the ink is dried while the ink supplied from the ink fountain is transferred onto the web via the rollers, the plate cylinder, and the blanket cylinder. As a result, the transferability and the image-forming performance of the ink are degraded, which may result in a degradation of a quality of printing on the web.

To solve the above problems, in a conventional web printing press, for example, as disclosed in Japanese Patent Application Laid-open No. 2001-502253, a printing unit includes an inking mechanism, a plate cylinder, and a blanket cylinder. The inking mechanism, the plate cylinder, and the blanket cylinder are arranged on a side wall of the printing unit, and at least partially surrounded by a housing so that a surrounding atmosphere within at least a semi-enclosed area of the printing unit can be maintained. Then, a chemical agent is selectively added to the atmosphere within the semi-enclosed area to prevent the ink from being dried quickly.

The above conventional printing unit disclosed in Japanese Patent Application Laid-open No. 2001-502253 makes it possible to prevent the ink from being dried quickly by adding the chemical agent to the atmosphere surrounding the inking mechanism, the plate cylinder, and the blanket cylinder. However, a water content of the ink to obtain a high transferability of the ink between the cylinders is significantly different from a water content of the ink to obtain a good image-forming performance on the plate cylinder. For example, in a case of using a water-based ink, when a water content of the ink increases, the transferability of the ink is improved because a flowability of the ink increases; however, the image-forming performance is degraded. Conversely, when the water content of the ink decreases, the transferability of the ink is degraded because the flowability of the ink decreases; however, the image-forming performance is improved. Therefore, even though the chemical agent is added to the atmosphere surrounding the inking mechanism, the plate cylinder, and the blanket cylinder to prevent the ink from being dried quickly, it is still difficult to improve the printing quality.

### SUMMARY OF THE INVENTION

It is an object of the present invention to at least partially solve the problems in the conventional technology.

A printing press according to one aspect of the present invention includes an ink supplying unit that supplies a water-based ink having a predetermined water content set in advance; an ink form roller that receives the water-based ink from the ink supplying unit; a plate cylinder that is in contact with the ink form roller, and receives the water-based ink from the ink form roller; and a water-content decreasing unit that decreases the water content of the water-based ink on the ink form roller.

A printing press according to another aspect of the present invention includes an ink supplying unit that supplies a oil-based ink having a predetermined water content set in advance; an ink form roller that receives the oil-based ink from the ink supplying unit; a plate cylinder that is in contact with the ink form roller, and receives the oil-based ink from the ink form roller; and a water-content increasing unit that increases the water content of the oil-based ink on the ink form roller.

A printing method according to still another aspect of the present invention includes supplying a water-based ink having a predetermined water content set in advance to an ink form roller; and forming an image of the water-based ink by transferring the water-based ink on the ink form roller onto a plate cylinder while decreasing the water content of the water-based ink on the ink form roller.

A printing method according to still another aspect of the present invention includes supplying a oil-based ink having a predetermined water content set in advance to an ink form roller; and forming an image of the oil-based ink by transferring the oil-based ink on the ink form roller onto a plate cylinder while increasing the water content of the oil-based ink on the ink form roller.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a printing unit included in a printing press according to a first embodiment of the present invention;

FIG. 2 is a schematic diagram of the printing press according to the first embodiment;

FIG. 3 is a schematic diagram of a printing unit included in a printing press according to a second embodiment of the present invention;

FIG. 4 is a schematic diagram of a printing unit included in a printing press according to a third embodiment of the present invention;

FIG. 5 is a schematic diagram of a printing unit included in a printing press according to a fourth embodiment of the present invention;

FIG. 6 is a schematic diagram of a printing press according to a fifth embodiment of the present invention; and

FIG. 7 is a schematic diagram of a printing unit included in a printing press according to a sixth embodiment of the present invention.

### DETAILED DESCRIPTION OF THE PREFERRED EMBODIMENTS

Exemplary embodiments of the present invention are explained in detail below with reference to the accompanying drawings. The present invention is not limited to the embodiments.

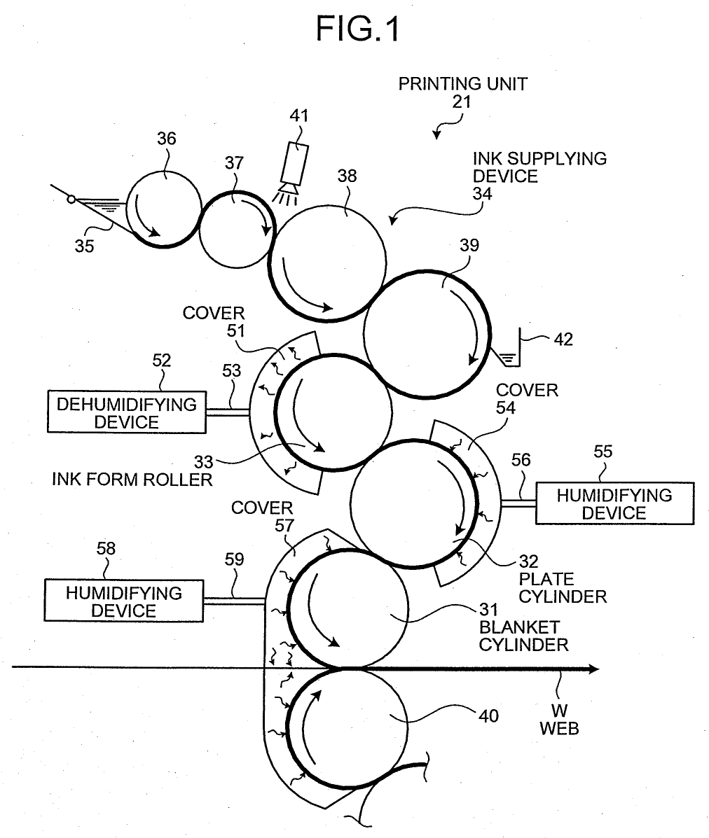

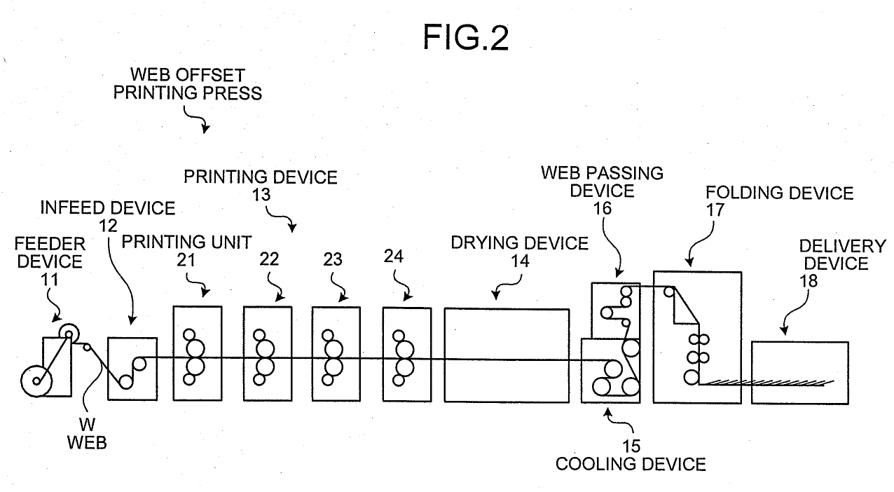

FIG. 1 is a schematic diagram of a printing unit included in a printing press according to a first embodiment of the present invention. FIG. 2 is a schematic diagram of the printing press according to the first embodiment.

The printing press according to the first embodiment is a web offset printing press using a water-based ink, and includes a feeder device 11, an infeed device 12, a printing device 13, a drying device 14, a cooling device 15, a web passing device 16, a folding device 17, and a delivery device 18 (see FIG. 2).

The feeder device 11 includes a reel stand and a web splicing device. Two web rolls, including a first web roll and a second web roll, are mounted on the reel stand. A web (printing paper) pulled out from the first web roll is connected to a web of the second web roll by the web splicing device, so that the web can be fed continuously. The infeed device 12 feeds the web from the feeder device 11 to the printing device 13. The printing device 13 includes four printing units 21, 22, 23, and 24 for cyan, magenta, yellow, and black water-based inks respectively. The printing units 21, 22, 23, and 24 are arranged to be aligned along a feeding direction of the web. The drying device 14 dries water-based inks on the web printed by the printing device 13. The cooling device 15 cools the web dried by the drying device 14 down to an appropriate temperature because a temperature of the dried web is excessively high. The web passing device 16 passes the cooled web to the folding device 17. The folding device 17 folds and cuts the web into a predetermined size, and further folds the cut webs into a predetermined size to form folded papers. The delivery device 18 delivers the folded papers to outside the printing press.

In this manner, a roll-like web W is pulled out from the web roll by the feeder device 11, and fed to the printing device 13 by the infeed device 12. Then, a multicolor image is printed on the web W by the printing units 21, 22, 23, and 24 in the printing device 13. After water-based inks on the printed web W are dried by the drying device 14, the web W is cooled down by the cooling device 15, and passed to the folding device 17 by the web passing device 16. The web W is formed into folded papers by the folding device 17, and the folded papers are delivered outside the printing press by the delivery device 18.

Each of the printing units 21, 22, 23, and 24 is a perfecting printing unit capable of printing images on both front and rear surfaces of the web W in parallel. The printing units 21, 22, 23, and 24 have substantially the same configuration except for a color of the water-based ink to be used. Therefore, out of the printing units 21, 22, 23, and 24, the printing unit 21 is taken as an example. A case where the printing unit 21 prints out an image on a front surface of the web W is explained below.

As shown in FIG. 1, the printing unit 21 includes a blanket cylinder 31, a plate cylinder 32, an ink form roller 33, and an ink supplying device 34. The blanket cylinder 31, the plate cylinder 32, and the ink form roller 33 are rotatably arranged on the upper side of a feeding path of the web W in such a manner that the blanket cylinder 31 and the plate cylinder 32, and also the plate cylinder 32 and the ink form roller 33 have contact with each other. The ink supplying device 34 is arranged above the ink form roller 33. The ink supplying device 34 supplies a water-based ink having a predetermined water rate (a predetermined water content) that is set in advance to the ink form roller 33. The ink form roller 33 is a rubber roller having an elastic portion on its surface. Upon receiving the water-based ink from the ink supplying device 34, the ink form roller 33 passes the received water-based ink to the plate cylinder 32. The plate cylinder 32 is a metallic roller having a plate (not shown) on its surface. Upon receiving the water-based ink from the ink form roller 33 by having contact with the ink form roller 33, the plate cylinder 32 passes the received water-based ink to the blanket cylinder 31. The blanket cylinder 31 is a rubber roller having an elastic portion on its surface. Upon receiving the water-based ink from the plate cylinder 32 by having contact with the plate cylinder 32, the blanket cylinder 31 transfers the received water-based ink onto the front surface of the web W as a printing image.

The ink supplying device 34 includes an ink fountain 35, an ink fountain roller 36, an ink transfer roller 37, an ink kneading roller 38, and an ink oscillating roller 39. A water-based ink is retained in the ink fountain 35. The ink fountain roller 36 is arranged in the ink fountain 35. The ink transfer roller 37 is arranged between the ink fountain roller 36 and the ink kneading roller 38 by having contact with both the ink fountain roller 36 and the ink kneading roller 38. The ink oscillating roller 39 is arranged between the ink kneading roller 38 and the ink form roller 33 by having contact with both the ink kneading roller 38 and the ink form roller 33. The ink fountain roller 36 kneads the water-based ink retained in the ink fountain 35, and passes an appropriate amount of the water-based ink, which is adjusted by an ink key (not shown), to the ink transfer roller 37.

In accordance with rotations of the rollers in the ink supplying device 34, the appropriate amount of the ink is supplied from the ink fountain 35 to the ink transfer roller 37 by the ink fountain roller 36. The water-based ink is moderately kneaded by being passed through the ink kneading roller 38 and the ink oscillating roller 39, so that a thin film is formed on a surface of the water-based ink. After that, the water-based ink is passed from the ink oscillating roller 39 to the ink form roller 33, and further passed from the ink form roller 33 to a plate surface of the plate cylinder 32. Then, the water-based ink on the plate surface is transferred onto the blanket cylinder 31. When the web W is sandwiched between the blanket cylinder 31 and a blanket cylinder 40 for rear-side printing, a predetermined degree of printing pressure is applied to the web W, so that the water-based ink on the blanket cylinder 31 is further transferred onto the front surface of the web W as a printing image.

A water flow mechanism (not shown) for flowing water to the ink oscillating roller 39 is provided to the ink supplying device 34. A surface temperature of the ink oscillating roller 39 can be controlled by the water flow mechanism so as to prevent a moisture evaporation of the water-based ink. In addition, dampening water is provided to a surface of the ink oscillating roller 39 by the water flow mechanism, so that the water-based ink can be emulsified with the dampening water.

The ink supplying device 34 further includes a spray 41 and a washing-agent collecting unit 42. The spray 41 sprays a washing agent on the ink transfer roller 37. The washing-agent collecting unit 42 collects the washing agent passed onto the ink oscillating roller 39. Upon termination of printing, a supply of the water-based ink from the ink fountain 35 is stopped, and the spray 41 sprays a washing agent on a surface of the ink transfer roller 37. The washing agent is passed through the ink transfer roller 37, the ink kneading roller 38, and the ink oscillating roller 39, so that the residue water-based ink attached to surfaces of those rollers can be cleaned by the washing agent. The washing agent on the ink oscillating roller 39 is scraped out and collected by a blade of the washing-agent collecting unit 42.

The printing unit 21 further includes a cover 51 and a dehumidifying device 52, as a water-content decreasing unit for decreasing a water content of the water-based ink on the ink form roller 33. The cover 51 covers a transferred portion of the ink form roller 33 where the water-based ink is transferred. The dehumidifying device 52 dehumidifies a space portion covered by the cover 51. The cover 51 has a curved shape along an outer circumferential surface of the ink form roller 33 and a boxy shape along an axial direction of the ink form roller 33. The cover 51 is arranged to cover the transferred portion of the ink form roller 33 (as indicated by a heavy line in FIG. 1) in such a manner that an opening of the cover 51 faces the outer circumferential surface of the ink form roller 33 with keeping a predetermined distance.

The dehumidifying device 52 is connected to the cover 51 via a connection path 53. The dehumidifying device 52 dehumidifies the space portion covered by the cover 51 to decrease a water content of the water-based ink on the ink form roller 33. Specifically, the dehumidifying device 52 includes a dry-air supplying unit, a suction unit, and a hot-air supplying unit. The dry-air supplying unit supplies dry air to the space portion. The suction unit suctions air of the space portion. The hot-air supplying unit supplies hot air to the space portion. Alternatively, a water flow mechanism identical to that is in the ink oscillating roller 39 can be provided instead of the dehumidifying device 52 so as to decrease a water content of the water-based ink by flowing hot water to the ink form roller 33.

Moreover, the printing unit 21 further includes a cover 54 and a humidifying device 55, as a first water-content increasing unit for increasing a water content of the water-based ink on the plate cylinder 32. The cover 54 covers a transferred portion of the plate cylinder 32 where the water-based ink is transferred. The humidifying device 55 humidifies a space portion covered by the cover 54. The cover 54 has a curved shape along an outer circumferential surface of the plate cylinder 32 and a boxy shape along an axial direction of the plate cylinder 32. The cover 54 is arranged to cover the transferred portion of the plate cylinder 32 (as indicated by the heavy line in FIG. 1) in such a manner that an opening of the cover 54 faces the outer circumferential surface of the plate cylinder 32 with keeping a predetermined distance.

The humidifying device 55 is connected to the cover 54 via a connection path 56. The humidifying device 55 humidifies the space portion covered by the cover 54 to increase a water content of the water-based ink on the plate cylinder 32. Specifically, the humidifying device 55 includes a humidified-air supplying unit and a cool-air supplying unit. The humidified-air supplying unit supplies humidified air (such as nanometer-size mist or mist) to the space portion. The cool-air supplying unit supplies cool air to the space portion.

In addition, the printing unit 21 further includes a cover 57 and a humidifying device 58, as a second water-content increasing unit for increasing a water content of the water-based ink on the blanket cylinder 31 and a water content of the web W. The cover 57 covers a transferred portion of the blanket cylinder 31 where the water-based ink is transferred and the front surface of the web W. The humidifying device 58 humidifies a space portion covered by the cover 57. The cover 57 has a curved shape along an outer circumferential surface of the blanket cylinder 31 and a boxy shape along an axial direction of the blanket cylinder 31 and a width direction of the web W. The cover 57 is arranged to cover the transferred portion of the blanket cylinder 31 (as indicated by the heavy line in FIG. 1) and the front surface of the web W in such a manner that an opening of the cover 57 faces the outer circumferential surface of the blanket cylinder 31 and the front surface of the web W with keeping a predetermined distance.

The humidifying device 58 is connected to the cover 57 via a connection path 59. The humidifying device 58 humidifies the space portion covered by the cover 57 to increase a water content of the water-based ink on the blanket cylinder 31 and a water content of the web W. Specifically, in the same manner as the humidifying device 55, the humidifying device 58 includes a humidified-air supplying unit and a cool-air supplying unit. The humidified-air supplying unit supplies humidified air (nanometer-size mist) to the space portion. The cool-air supplying unit supplies cool air to the space portion.

An operation of the printing unit 21 is explained in detail below. The water-based ink retained in the ink fountain 35 is made of water, pigment, resin, and the like. A water content of the water-based ink is controlled to ensure a high transferability between the rollers. In accordance with rotations of the rollers included in the ink supplying device 34, an appropriate amount of the water-based ink, which is adjusted by the ink fountain roller 36, is supplied from the ink fountain 35 to the ink form roller 33 via the ink transfer roller 37, the ink kneading roller 38, and the ink oscillating roller 39. At this time, the water content of the water-based ink is controlled to ensure the high transferability (i.e., a high flowability of the ink), so that the water-based ink can be supplied to the ink form roller 33 properly.

When the water-based ink on the ink form roller 33 comes to the space portion covered by the cover 51 in accordance with the rotation of the ink form roller 33, a water content of the water-based ink on the ink form roller 33 decreases due to the dehumidification by the dehumidifying device 52. Then, the water-based ink on the ink form roller 33 is transferred onto the plate surface of the plate cylinder 32 in accordance with the rotation of the ink form roller 33. At this time, the water content of the water-based ink on the ink form roller 33 decreases, so that the flowability of the water-based ink also decreases. As a result, a good image-forming performance can be obtained. Therefore, the water-based ink can be transferred onto the plate surface of the plate cylinder 32 with sharpening its edges.

When the water-based ink on the plate surface of the plate cylinder 32 comes to the space portion covered by the cover 54 in accordance with the rotation of the plate cylinder 32, a water content of the water-based ink on the plate cylinder 32 increases due to the humidification by the humidifying device 55. Then, the water-based ink on the plate surface of the plate cylinder 32 is transferred onto the blanket cylinder 31 in accordance with the rotation of the plate cylinder 32. At this time, the water content of the water-based ink increases, so that the flowability of the water-based ink increases again. As a result, a high transferability of the water-based ink can be obtained. Therefore, the water-based ink can be properly transferred onto a surface of the blanket cylinder 31 as a printing image.

When the water-based ink on the surface of the blanket cylinder 31 comes to the space portion covered by the cover 57 in accordance with the rotation of the blanket cylinder 31, a water content of the water-based ink on the blanket cylinder 31 further increases due to the humidification by the humidifying device 58. On the other hand, when the web W fed by the blanket cylinder 31 comes to the space portion covered by the cover 57, a water content of the front surface of the web W increases due to the humidification by the humidifying device 58. Then, when the water-based ink on the blanket cylinder 31 comes to the web W in accordance with the rotation of the blanket cylinder 31, a predetermined degree of printing pressure is applied to the web W by being sandwiched between the blanket cylinder 31 and the blanket cylinder 40 for the rear-side printing, so that the water-based ink on the blanket cylinder 31 is transferred onto the front surface of the web W as the printing image. At this time, the water content of the water-based ink on the blanket cylinder 31 and the water content of the front surface of the web W increase, so that a high transferability of the water-based ink can be obtained. Therefore, the printing image can be accurately transferred onto the front surface of the web W.

The transferability and the image-forming performance of the water-based ink among the ink form roller 33, the plate cylinder 32, the blanket cylinder 31, and the web W are directly associated with a printing quality. Therefore, an operator needs to perform drive controls (ON/OFF controls or viability controls) of the dehumidifying device 52 and the humidifying devices 55 and 58 depending on a printing status of the web W. Also, as described above, the printing unit 21 is the perfecting printing unit capable of printing images on the front and rear surfaces of the web W in parallel, so that the blanket cylinder 40, the plate cylinder, the ink form roller, the ink supplying device, the covers, the dehumidifying device, the humidifying devices, and the like are arranged in the lower side of the feeding path of the web W so as to print out an image on the rear surface of the web W in the same manner as the front surface of the web W, i.e., by adjusting a water content of the water-based ink and a water content of the rear surface of the web W. In same manner as the printing unit 21, the printing units 22, 23, and 24 also perform the same operation as described above.

In this manner, in the printing press according to the first embodiment, each of the printing units 21 to 24 includes the ink supplying device 34, the ink form roller 33, the plate cylinder 32, and the blanket cylinder 31. The ink supplying device 34 supplies a water-based ink having a predetermined water content to the ink form roller 33. Upon receiving the water-based ink from the ink supplying device 34, the ink form roller 33 transfers the received water-based ink onto the plate cylinder 32 by having contact with the plate cylinder 32. The plate cylinder 32 further transfers the water-based ink onto the blanket cylinder 31 by having contact with the blanket cylinder 31. Then, the blanket cylinder 31 transfers the water-based ink onto the web W as a printing image. In addition, each of the printing units 21 to 24 further includes the cover 51 and the dehumidifying device 52, as the water-content decreasing unit for decreasing a water content of the water-based ink on the ink form roller 33. The cover 51 covers the transferred portion of the ink form roller 33 where the water-based ink is transferred. The dehumidifying device 52 dehumidifies the space portion covered by the cover 51.

Therefore, when the water-based ink supplied from the ink supplying device 34 is passed to the plate cylinder 32 via the ink form roller 33, an image of the water-based ink is formed on the plate cylinder 32. At this time, a water content of the water-based ink on the ink form roller 33 decreases due to the dehumidification by the dehumidifying device 52. Namely, while the water-based ink is supplied from the ink supplying device 34 to the ink form roller 33, the predetermined water content of the water-based ink is ensured, so that the high transferability of the water-based ink can be obtained. After that, while the water-based ink is passed from the ink form roller 33 to the plate cylinder 32, the water content of the water-based ink decreases due to the dehumidification by the dehumidifying device 52, so that the good image-forming performance can be obtained. As a result, it is possible to improve the printing quality. Furthermore, the water content of the water-based ink on the ink form roller 33 can efficiently decrease with a simple configuration.

Moreover, in the printing press according to the first embodiment, each of the printing units 21 to 24 further includes the cover 54 and the humidifying device 55, as the first water-content increasing unit for increasing a water content of the water-based ink on the plate cylinder 32. The cover 54 covers the transferred portion of the plate cylinder 32 where the water-based ink is transferred. The humidifying device 55 humidifies the space portion covered by the cover 54. After the water content of the water-based ink on the ink form roller 33 decreases due to the dehumidification by the dehumidifying device 52, a water content of the water-based ink on the plate cylinder 32 increases due to the humidification by the humidifying device 55. Therefore, when the water-based ink on the plate cylinder 32 is transferred onto the blanket cylinder 31, an appropriate water content of the water-based ink is ensured, and thus it is possible to improve the transferability of the water-based ink.

Furthermore, in the printing press according to the first embodiment, each of the printing units 21 to 24 further includes the cover 57 and the humidifying device 58, as the second water-content increasing unit for increasing a water content of the water-based ink on the blanket cylinder 31 and a water content of the front surface of the web W. The cover 57 covers the transferred portion of the blanket cylinder 31 where the water-based ink is transferred and the front surface of the web W. The humidifying device 58 humidifies the space portion covered by the cover 57. When the water-based ink on the blanket cylinder 31 is transferred onto the front surface of the web W, a water content of the water-based ink on the blanket cylinder 31 and a water content of the front surface of the web W increase due to the humidification by the humidifying device 58. Therefore, when the water-based ink on the blanket cylinder 31 is transferred onto the front surface of the web W, an appropriate water content of the water-based ink is ensured, and thus it is possible to improve the transferability of the water-based ink.

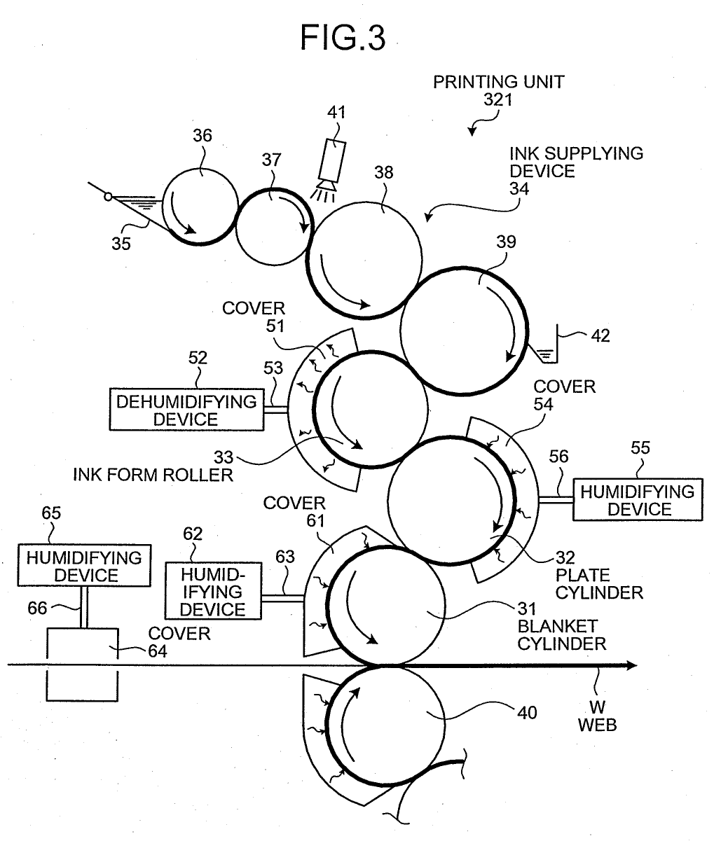

FIG. 3 is a schematic diagram of a printing unit 321 included in a web offset printing press according to a second embodiment of the present invention. The portions identical to those in FIG. 1 for the first embodiment are denoted with the same reference numerals, and the description of those portions is omitted.

As shown in FIG. 3, in the printing unit 321, the blanket cylinder 31, the plate cylinder 32, and the ink form roller 33 are rotatably arranged on the upper side of the feeding path of the web W in such a manner that the blanket cylinder 31 and the plate cylinder 32 have contact with each other, and also the plate cylinder 32 and the ink form roller 33 have contact with each other.

The printing unit 321 includes the cover 51 and the dehumidifying device 52, as the water-content decreasing unit for decreasing a water content of the water-based ink on the ink form roller 33. The cover 51 covers the transferred portion of the ink form roller 33 where the water-based ink is transferred. The dehumidifying device 52 dehumidifies the space portion covered by the cover 51. Moreover, the printing unit 321 further includes the cover 54 and the humidifying device 55, as the first water-content increasing unit for increasing a water content of the water-based ink on the plate cylinder 32. The cover 54 covers the transferred portion of the plate cylinder 32 where the water-based ink is transferred. The humidifying device 55 humidifies the space portion covered by the cover 54.

Furthermore, the printing unit 321 further includes a cover 61 and a humidifying device 62, as a third water-content increasing unit for increasing a water content of the water-based ink on the blanket cylinder 31. The cover 61 covers a transferred portion of the blanket cylinder 31 where the water-based ink is transferred. The humidifying device 62 humidifies a space portion covered by the cover 61. The cover 61 has a curved shape along the outer circumferential surface of the blanket cylinder 31 and a boxy shape along the axial direction of the blanket cylinder 31. The cover 61 is arranged to cover the transferred portion of the blanket cylinder 31 (as indicated by a heavy line in FIG. 3) in such a manner that an opening of the cover 61 faces the outer circumferential surface of the blanket cylinder 31 with keeping a predetermined distance. The humidifying device 62 is connected to the cover 61 via a connection path 63. The humidifying device 62 humidifies the space portion covered by the cover 61 to increase a water content of the water-based ink on the blanket cylinder 31.

Furthermore, the printing unit 321 further includes a cover 64 and a humidifying device 65, as a fourth water-content increasing unit for increasing a water content of the water-based ink on a front surface of the web W fed by the blanket cylinder 31. The cover 64 covers the front surface of the web W. The humidifying device 65 humidifies a space portion covered by the cover 64. The cover 64 has a boxy shape along the width direction of the web W. The cover 64 is arranged to cover the front surface of the web W down to the blanket cylinder 31 in such a manner that an opening of the cover 64 faces the front surface of the web W with keeping a predetermined distance. The humidifying device 65 is connected to the cover 64 via a connection path 66. The humidifying device 65 humidifies the space portion covered by the cover 64 to increase a water content of the water-based ink on the web W.

When the water-based ink is supplied from the ink supplying device 34 to the ink form roller 33, the water-based ink is controlled to have the predetermined water content so as to obtain the high transferability (the high flowability) of the water-based ink. Therefore, the water-based ink can be supplied to the ink form roller 33 properly. Then, when the water-based ink on the ink form roller 33 comes to the space portion covered by the cover 51, a water content of the water-based ink on the ink form roller 33 decreases due to the dehumidification by the dehumidifying device 52. After that, the water-based ink on the ink form roller 33 is transferred onto the plate surface of the plate cylinder 32. At this time, the water content of the water-based ink on the ink form roller 33 decreases, so that the flowability of the water-based ink also decreases. As a result, a good image-forming performance can be obtained. Therefore, the water-based ink can be transferred onto the plate surface of the plate cylinder 32 with sharpening its edges.

When the water-based ink on the plate surface of the plate cylinder 32 comes to the space portion covered by the cover 54, a water content of the water-based ink on the plate cylinder 32 increases due to the humidification by the humidifying device 55. Then, the water-based ink on the plate surface of the plate cylinder 32 is transferred onto the blanket cylinder 31. At this time, the water content of the water-based ink increases, so that the flowability of the water-based ink increases again. As a result, a high transferability of the water-based ink can be obtained. Therefore, the water-based ink can be properly transferred onto a surface of the blanket cylinder 31 as a printing image.

When the water-based ink on the blanket cylinder 31 comes to the space portion covered by the cover 61, a water content of the water-based ink on the blanket cylinder 31 further increases due to the humidification by the humidifying device 62. On the other hand, when the web W fed by the blanket cylinder 31 comes to the space portion covered by the cover 64, a water content of the front surface of the web W increases due to the humidification by the humidifying device 65. Then, when the water-based ink on the blanket cylinder 31 comes to the web W, the water-based ink on the blanket cylinder 31 is transferred onto the front surface of the web W as the printing image. At this time, the water content of the water-based ink on the blanket cylinder 31 and the water content of the front surface of the web W increase, so that a high transferability of the water-based ink can be obtained. Therefore, the printing image can be accurately transferred onto the front surface of the web W.

In this manner, in the printing press according to the second embodiment, the printing unit 321 includes the cover 51 and the dehumidifying device 52, as the water-content decreasing unit for decreasing a water content of the water-based ink on the ink form roller 33, and also the cover 54 and the humidifying device 55, as the first water-content increasing unit for increasing a water content of the water-based ink on the plate cylinder 32.

Therefore, a water content of the water-based ink on the ink form roller 33 decreases due to the dehumidification by the dehumidifying device 52, so that the good image-forming performance can be obtained. After that, a water content of the water-based ink on the plate cylinder 32 increases due to the humidification by the humidifying device 55, so that the transferability of the water-based ink can be improved. As a result, it is possible to improve the printing quality.

Furthermore, in the printing press according to the second embodiment, the printing unit 321 further includes the cover 61 and the humidifying device 62, as the third water-content increasing unit for increasing a water content of the water-based ink on the blanket cylinder 31, and also the cover 64 and the humidifying device 65, as the fourth water-content increasing unit for increasing a water content of the front surface of the web W.

Therefore, when the water-based ink on the blanket cylinder 31 is transferred onto the front surface of the web W, a water content of the water-based ink on the blanket cylinder 31 increases due to the humidification by the humidifying device 62, and a water content of the front surface of the web W increases due to the humidification by the humidifying device 65. As a result, when the water-based ink on the blanket cylinder 31 is transferred onto the front surface of the web W, an appropriate water content of the water-based ink is ensured, and thus it is possible to improve the transferability of the water-based ink.

In the second embodiment, the covers 61 and 64 are separately arranged, so that sealing performances in the space portions covered by the covers 61 and 64 can be improved as compared with that is in the space portion covered by the cover 57 for the first embodiment. Therefore, the water-based ink on the blanket cylinder 31 and the front surface of the web W can be efficiently humidified, and thus it is possible to reduce an operating cost of the printing press.

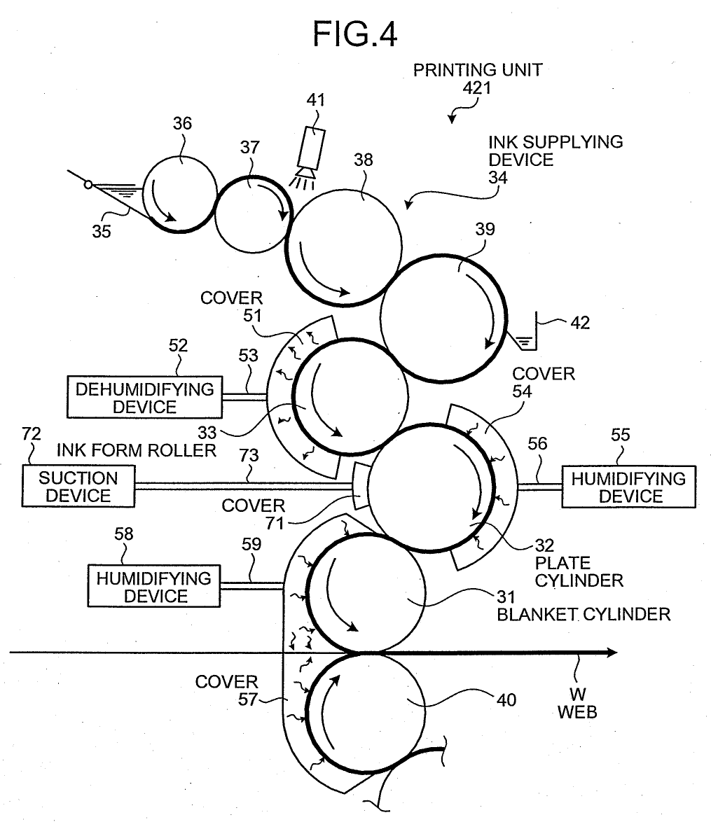

FIG. 4 is a schematic diagram of a printing unit 421 included in a web offset printing press according to a third embodiment of the present invention. The portions identical to those in FIG. 1 for the first embodiment are denoted with the same reference numerals, and the description of those portions is omitted.

As shown in FIG. 4, in the printing unit 421, the blanket cylinder 31, the plate cylinder 32, and the ink form roller 33 are rotatably arranged on the upper side of the feeding path of the web W in such a manner that the blanket cylinder 31 and the plate cylinder 32 have contact with each other, and also the plate cylinder 32 and the ink form roller 33 have contact with each other.

The printing unit 421 includes the cover 51 and the dehumidifying device 52, as the water-content decreasing unit for decreasing a water content of the water-based ink on the ink form roller 33. The cover 51 covers the transferred portion of the ink form roller 33 where the water-based ink is transferred. The dehumidifying device 52 dehumidifies the space portion covered by the cover 51. Moreover, the printing unit 421 further includes the cover 54 and the humidifying device 55, as the first water-content increasing unit for increasing a water content of the water-based ink on the plate cylinder 32. The cover 54 covers the transferred portion of the plate cylinder 32 where the water-based ink is transferred. The humidifying device 55 humidifies the space portion covered by the cover 54. Furthermore, the printing unit 421 further includes the cover 57 and the humidifying device 58, as the second water-content increasing unit for increasing a water content of the water-based ink on the blanket cylinder 31 and a water content of the front surface of the web W. The cover 57 covers the transferred portion of the blanket cylinder 31 where the water-based ink is transferred and the front surface of the web W. The humidifying device 58 humidifies the space portion covered by the cover 57.

The difference between the printing unit 21 according to the first embodiment and the printing unit 421 according to the third embodiment is that the printing unit 421 further includes a dehumidifying unit for dehumidifying a surface of the plate cylinder 32 after the water-based ink on the plate cylinder 32 is transferred onto the blanket cylinder 31. As the dehumidifying unit, the printing unit 421 includes a cover 71 and a suction device 72. The cover 71 covers a portion of the plate surface of the plate cylinder 32 where the plate cylinder 32 is going to receive the water-based ink from the ink form roller 33 by having contact with the ink form roller 33 after the water-based ink on the plate cylinder 32 is transferred onto the blanket cylinder 31. The suction device 72 suctions air in a space portion covered by the cover 71. The cover 71 has a curved shape along the outer circumferential surface of the plate cylinder 32 and a boxy shape along the axial direction of the plate cylinder 32. The cover 71 is arranged to cover a non-transferred portion of the plate cylinder 32 where the water-based ink is not transferred (as indicated by a thin line in FIG. 4) in such a manner that an opening of the cover 71 faces the outer circumferential surface of the plate cylinder 32 with keeping a predetermined distance.

The suction device 72 is connected to the cover 71 via a connection path 73. The suction device 72 dehumidifies the surface of the plate cylinder 32 by suctioning air in the space portion covered by the cover 71. Instead of the suction device 72, the dry-air supplying unit that supplies dry air to the space portion or the hot-air supplying unit that supplies hot air to the space portion can be used as the dehumidifying unit.

When the water-based ink is supplied from the ink supplying device 34 to the ink form roller 33, the water-based ink is controlled to have the predetermined water content so as to obtain the high transferability (the high flowability) of the water-based ink. Therefore, the water-based ink can be supplied to the ink form roller 33 properly. Then, when the water-based ink on the ink form roller 33 comes to the space portion covered by the cover 51, a water content of the water-based ink on the ink form roller 33 decreases due to the dehumidification by the dehumidifying device 52. After that, the water-based ink on the ink form roller 33 is transferred onto the plate surface of the plate cylinder 32. At this time, the water content of the water-based ink on the ink form roller 33 decreases, so that the flowability of the water-based ink also decreases. As a result, a good image-forming performance can be obtained. Therefore, the water-based ink can be transferred onto the plate surface of the plate cylinder 32 with sharpening its edges.

When the water-based ink on the plate surface of the plate cylinder 32 comes to the space portion covered by the cover 54, a water content of the water-based ink on the plate cylinder 32 increases due to the humidification by the humidifying device 55. Then, the water-based ink on the plate surface of the plate cylinder 32 is transferred onto the blanket cylinder 31. At this time, the water content of the water-based ink increases, so that the flowability of the water-based ink increases again. As a result, a high transferability of the water-based ink can be obtained. Therefore, the water-based ink can be properly transferred onto a surface of the blanket cylinder 31 as a printing image.

After the water-based ink on the plate cylinder 32 is transferred onto the blanket cylinder 31, when the non-transferred portion of the plate cylinder 32 comes to the space portion covered by the cover 71, the plate surface of the plate cylinder 32 is dehumidified because the space portion gets in a negative pressure state due to the suctioning by the suction device 72. Therefore, when the water-based ink on the ink form roller 33 is newly passed to the plate surface of the plate cylinder 32, the plate surface of the plate cylinder 32 is dehumidified, so that a flowability of the water-based ink passed from the ink form roller 33 decreases. As a result, it is possible to improve the image-forming performance.

When the water-based ink on the blanket cylinder 31 comes to the space portion covered by the cover 57, a water content of the water-based ink on the blanket cylinder 31 further increases due to the humidification by the humidifying device 58. On the other hand, when the web W fed by the blanket cylinder 31 comes to the space portion covered by the cover 57, a water content of the front surface of the web W increases due to the humidification by the humidifying device 58. Then, when the water-based ink on the blanket cylinder 31 comes to the web W, the water-based ink on the blanket cylinder 31 is transferred onto the front surface of the web W as the printing image. At this time, the water content of the water-based ink on the blanket cylinder 31 and the water content of the front surface of the web W increase, so that a high transferability of the water-based ink can be obtained. Therefore, the printing image can be accurately transferred onto the front surface of the web W.

In this manner, in the printing press according to the third embodiment, the printing unit 421 includes the cover 51 and the dehumidifying device 52, as the water-content decreasing unit for decreasing a water content of the water-based ink on the ink form roller 33, and also the cover 54 and the humidifying device 55, as the first water-content increasing unit for increasing a water content of the water-based ink on the plate cylinder 32. In addition, the printing unit 421 further includes the cover 71 and the suction device 72, as the dehumidifying unit for dehumidifying the surface of the plate cylinder 32 after the water-based ink on the plate cylinder 32 is transferred onto the blanket cylinder 31.

Therefore, a water content of the water-based ink on the ink form roller 33 decreases due to the dehumidification by the dehumidifying device 52, so that the good image-forming performance can be obtained. After that, a water content of the water-based ink on the plate cylinder 32 increases due to the humidification by the humidifying device 55, so that the transferability of the water-based ink can be improved. Then, the plate surface of the plate cylinder 32 is dehumidified in such a manner that the suction device 72 suctions air in the space portion covered by the cover 71, i.e., in the non-transferred portion of the plate cylinder 32, so that the flowability of the water-based ink passed from the ink form roller 33 decreases, and thus the good image-forming performance can be obtained. As a result, it is possible to improve the printing quality.

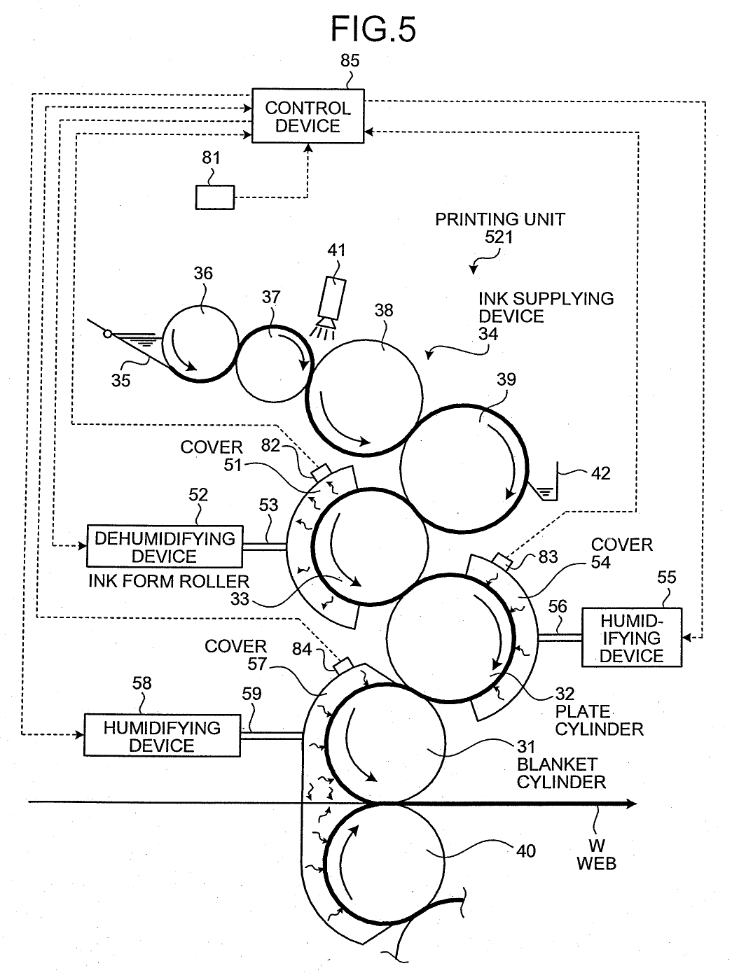

FIG. 5 is a schematic diagram of a printing unit 521 included in a web offset printing press according to a fourth embodiment of the present invention. The portions identical to those in FIG. 1 for the first embodiment are denoted with the same reference numerals, and the description of those portions is omitted.

As shown in FIG. 5, in the printing unit 521, the blanket cylinder 31, the plate cylinder 32, and the ink form roller 33 are rotatably arranged on the upper side of the feeding path of the web W in such a manner that the blanket cylinder 31 and the plate cylinder 32 have contact with each other, and also the plate cylinder 32 and the ink form roller 33 have contact with each other.

The printing unit 521 includes the cover 51 and the dehumidifying device 52, as the water-content decreasing unit for decreasing a water content of the water-based ink on the ink form roller 33. The cover 51 covers the transferred portion of the ink form roller 33 where the water-based ink is transferred. The dehumidifying device 52 dehumidifies the space portion covered by the cover 51. Moreover, the printing unit 521 further includes the cover 54 and the humidifying device 55, as the first water-content increasing unit for increasing a water content of the water-based ink on the plate cylinder 32. The cover 54 covers the transferred portion of the plate cylinder 32 where the water-based ink is transferred. The humidifying device 55 humidifies the space portion covered by the cover 54. Furthermore, the printing unit 521 further includes the cover 57 and the humidifying device 58, as the second water-content increasing unit for increasing a water content of the water-based ink on the blanket cylinder 31 and a water content of the front surface of the web W. The cover 57 covers the transferred portion of the blanket cylinder 31 where the water-based ink is transferred and the front surface of the web W. The humidifying device 58 humidifies the space portion covered by the cover 57.

In addition, the printing unit 521 further includes a peripheral-portion humidity sensor 81 as a peripheral-portion humidity detecting unit and space-portion humidity sensors 82, 83, and 84 as a space-portion humidity detecting unit, and a control device 85 is provided to the printing press according to the fourth embodiment. The peripheral-portion humidity sensor 81 detects a peripheral humidity around the ink form roller 33 and the plate cylinder 32, i.e., a humidity in a building where the printing unit 521 is located. The space-portion humidity sensors 82, 83, and 84 respectively detect a humidity in each of the space portions covered by the covers 51, 54, and 57. Results of the detection by the peripheral-portion humidity sensor 81 and the space-portion humidity sensors 82, 83, and 84 are input to the control device 85. The control device 85 controls the dehumidifying device 52 and the humidifying devices 55 and 58 based on the results of the detection.

Specifically, when a humidity in the building is high, a degree of dryness of the water-based ink to be supplied from the ink supplying device 34 to the ink form roller 33 is low. Therefore, the control device 85 controls the dehumidifying device 52 to raise its dehumidification level so as to increase a degree of dehumidification of the water-based ink on the ink form roller 33, and also controls the humidifying devices 55 and 58 to lower their humidification levels so as to decrease a degree of humidification of the water-based ink on the plate cylinder 32 and the blanket cylinder 31. On the other hand, when a humidity in the building is low, a degree of dryness of the water-based ink to be supplied from the ink supplying device 34 to the ink form roller 33 is high. Therefore, the control device 85 controls the dehumidifying device 52 to lower its dehumidification level so as to decrease a degree of dehumidification of the water-based ink on the ink form roller 33, and also controls the humidifying devices 55 and 58 to raise their humidification levels so as to increase a degree of humidification of the water-based ink on the plate cylinder 32 and the blanket cylinder 31. An optimal humidity in each of the space portions covered by the covers 51, 54, and 57 varies depending on a humidity in the building. Therefore, the control device 85 controls the dehumidifying device 52 and the humidifying devices 55 and 58 so that a humidity in each of the space portions covered by the covers 51, 54, and 57, which is detected by the space-portion humidity sensors 82, 83, and 84, can be adjusted to be the optimal humidity that is set based on the humidity in the building, which is detected by the peripheral-portion humidity sensor 81.

When the water-based ink is supplied from the ink supplying device 34 to the ink form roller 33, the water-based ink is controlled to have the predetermined water content so as to obtain the high transferability (the high flowability) of the water-based ink. Therefore, the water-based ink can be supplied to the ink form roller 33 properly. Then, when the water-based ink on the ink form roller 33 comes to the space portion covered by the cover 51, a water content of the water-based ink on the ink form roller 33 decreases due to the dehumidification by the dehumidifying device 52. After that, the water-based ink on the ink form roller 33 is transferred onto the plate surface of the plate cylinder 32. At this time, the water content of the water-based ink on the ink form roller 33 decreases, so that the flowability of the water-based ink also decreases. As a result, a good image-forming performance can be obtained. Therefore, the water-based ink can be transferred onto the plate surface of the plate cylinder 32 with sharpening its edges.

When the water-based ink on the plate surface of the plate cylinder 32 comes to the space portion covered by the cover 54, a water content of the water-based ink on the plate cylinder 32 increases due to the humidification by the humidifying device 55. Then, the water-based ink on the plate surface of the plate cylinder 32 is transferred onto the blanket cylinder 31. At this time, the water content of the water-based ink on the plate cylinder 32 increases, so that the flowability of the water-based ink increases again. As a result, a high transferability of the water-based ink can be obtained. Therefore, the water-based ink can be properly transferred onto a surface of the blanket cylinder 31 as a printing image.

When the water-based ink on the blanket cylinder 31 comes to the space portion covered by the cover 57, a water content of the water-based ink on the blanket cylinder 31 further increases due to the humidification by the humidifying device 58. On the other hand, when the web W fed by the blanket cylinder 31 comes to the space portion covered by the cover 57, a water content of the front surface of the web W increases due to the humidification by the humidifying device 58. Then, when the water-based ink on the blanket cylinder 31 comes to the web W, the water-based ink on the blanket cylinder 31 is transferred onto the front surface of the web W as the printing image. At this time, the water content of the water-based ink on the blanket cylinder 31 and the water content of the front surface of the web W increase, so that a high transferability of the water-based ink can be obtained. Therefore, the printing image can be accurately transferred onto the front surface of the web W.

During the printing of the water-based ink as described above, the control device 85 sets an optimal humidity in each of the space portions covered by the covers 51, 54, and 57 based on a humidity in the building, which is detected by the peripheral-portion humidity sensor 81, and controls the dehumidifying device 52 and the humidifying devices 55 and 58 so that a humidity in each of the space portions covered by the covers 51, 54, and 57, which is detected by the space-portion humidity sensors 82, 83, and 84, can be adjusted to be the optimal humidity. Therefore, a water content of the water-based ink, which is supplied from the ink supplying device 34 and transferred onto the web W via the ink form roller 33, the plate cylinder 32, and the blanket cylinder 31, can be properly adjusted depending on a peripheral environment. Thus, it is possible to obtain a high transferability and a good image-forming performance of the water-based ink.

In this manner, in the printing press according to the fourth embodiment, the transferred portion of the ink form roller 33 is covered by the cover 51 connected to the dehumidifying device 52, and the transferred portion of the plate cylinder 32 is covered by the cover 54 connected to the humidifying device 55, and the transferred portion of the blanket cylinder 31 and the front surface of the web W are covered by the cover 57 connected to the humidifying device 58. Then, the printing unit 521 includes the peripheral-portion humidity sensor 81 that detects a humidity in the building where the printing unit 521 is located, and the space-portion humidity sensors 82, 83, and 84 that respectively detect a humidity in each of the space portions covered by the covers 51, 54, and 57. The control device 85 controls the dehumidifying device 52 and the humidifying devices 55 and 58 based on results of the detection by the peripheral-portion humidity sensor 81 and the space-portion humidity sensors 82, 83, and 84.

Therefore, the control device 85 sets an optimal humidity in each of the space portions covered by the covers 51, 54, and 57 based on a humidity in the building, which is detected by the peripheral-portion humidity sensor 81, and controls the dehumidifying device 52 and the humidifying devices 55 and 58 so that a humidity in each of the space portions covered by the covers 51, 54, and 57, which is detected by the space-portion humidity sensors 82, 83, and 84, can be adjusted to be the optimal humidity. As a result, a water content of the water-based ink, which is supplied from the ink supplying device 34 and transferred onto the web W via the ink form roller 33, the plate cylinder 32, and the blanket cylinder 31, can be properly adjusted depending on a peripheral environment. Thus, it is possible to obtain a high transferability and a good image-forming performance of the water-based ink. Consequently, it is possible to improve the printing quality.

In the printing press according to the fourth embodiment, the control device 85 controls the dehumidifying device 52 and the humidifying devices 55 and 58 to change their dehumidification/humidification levels based on a humidity in the building, which is detected by the peripheral-portion humidity sensor 81, and a humidity in each of the space portions covered by the covers 51, 54, and 57, which is detected by each of the space-portion humidity sensors 82, 83, and 84. Alternatively, the control device 85 can control the dehumidifying device 52 and the humidifying devices 55 and 58 to be turned ON/OFF.

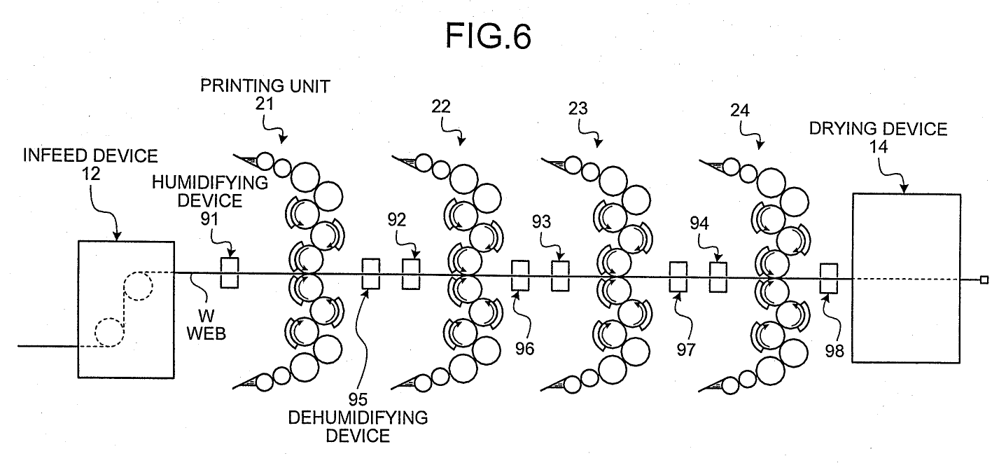

FIG. 6 is a schematic diagram of a printing press according to a fifth embodiment of the present invention. The portions identical to those in FIG. 2 for the first embodiment are denoted with the same reference numerals, and the description of those portions is omitted.

The printing press according to the fifth embodiment is a web offset printing press using a water-based ink, and includes the feeder device 11, the infeed device 12, the printing device 13, the drying device 14, the cooling device 15, the web passing device 16, the folding device 17, and the delivery device 18. The printing device 13 includes the printing units 21, 22, 23, and 24 for cyan, magenta, yellow, and black water-based inks respectively. The printing units 21, 22, 23, and 24 are arranged to be aligned along the feeding direction of the web. Each of the printing units 21, 22, 23, and 24 is a perfecting printing unit capable of printing images on a front and rear surfaces of the web W in parallel, so that two sets of the blanket cylinder, the plate cylinder, the ink form roller, the ink supplying device, the covers, the dehumidifying device, the humidifying devices, and the like are arranged in a symmetrical manner across the web. The images are printed on the front and rear surfaces of the web W by adjusting a water content of the water-based ink and water contents of the both surfaces of the web W.

The printing press according to the fifth embodiment further includes humidifying devices 91, 92, 93, and 94 for humidifying the both surfaces of the web W, and dehumidifying devices 95, 96, 97, and 98 for dehumidifying the both surfaces of the web W. The humidifying devices 91, 92, 93, and 94 are respectively arranged in the upstream side of the printing units 21, 22, 23, and 24 to be aligned along a conveyor line of the web W in the feeding direction of the web W. The dehumidifying devices 95, 96, 97, and 98 are respectively arranged in the downstream side of the printing units 21, 22, 23, and 24 to be aligned along the conveyor line of the web W in the feeding direction of the web W. For example, as shown in FIG. 6, the humidifying device 91 is arranged between the infeed device 12 and the printing unit 21, and the dehumidifying device 98 is arranged between the printing unit 24 and the drying device 14.

The both surfaces of the web W are humidified by the humidifying device 91 before the web W is fed to the printing unit 21, and images for the first color are perfecting printed on the both surfaces of the web W by the printing unit 21. At this time, water contents of the both surfaces of the web W increase due to the humidification by the humidifying device 91, so that a transferability of the first-color water-based ink on the blanket cylinder to be transferred onto the web W can be improved. Upon completion of the first-color perfecting printing by the printing unit 21, the both surfaces of the web W are dehumidified by the dehumidifying device 95 so as to support a surface dryness of the first-color water-based ink transferred onto the web W.

Subsequently, the both surfaces of the web W are humidified by the humidifying device 92, and images for the second color are perfecting printed on the both surfaces of the web W by the printing unit 22. At this time, water contents of non-image areas of the both surfaces of the web W, i.e., portions of the both surfaces of the web W where the water-based ink for the first-color images is not transferred increase due to the humidification by the humidifying device 92, so that a transferability of the second-color water-based ink on the blanket cylinder to be transferred onto the web W can be improved. Upon completion of the second-color perfecting printing by the printing unit 22, the both surfaces of the web W are dehumidified by the dehumidifying device 96 so as to support a surface dryness of the second-color water-based ink transferred onto the web W.

In the same manner as the printing units 21 and 22, images for the third and fourth colors are perfecting printed on the both surfaces of the web W by the printing units 23 and 24. Upon completion of the fourth-color perfecting printing by the printing unit 24, the both surfaces of the web W are dehumidified by the dehumidifying device 98 so as to support a surface dryness of the fourth-color water-based ink transferred onto the web W. Then, the water-based inks on the both surfaces of the web W are completely dried by the drying device 14. In this case, after the completion of the perfecting printing by each of the printing units 21, 22, 23, and 24, the water-based ink on the web W is dehumidified by each of the dehumidifying devices 95, 96, 97, and 98, so that a time for the drying by the drying device 14 can be reduced.

In this manner, in the printing press according to the fifth embodiment, the printing units 21, 22, 23, and 24 are arranged to be aligned along the conveyor line of the web W, and the humidifying devices 91, 92, 93, and 94 are respectively arranged in the upstream side of the printing units 21, 22, 23, and 24 on conveyor line of the web W in the feeding direction of the web W, and also the dehumidifying devices 95, 96, 97, and 98 are respectively arranged in the downstream side of the printing units 21, 22, 23, and 24 on conveyor line of the web W in the feeding direction of the web W.

Therefore, the web W is humidified by the humidifying devices 91, 92, 93, and 94 before an image is printed thereon, so that the transferability of the water-based ink on the blanket cylinder to be transferred onto the web W can be improved. Furthermore, the web W is dehumidified by the dehumidifying devices 95, 96, 97, and 98 after the image is printed thereon, so that a surface of the water-based ink transferred onto the web W can be dried, and thus a time for the drying by the drying device 14 can be reduced. Consequently, it is possible to reduce an operating cost of the printing press.

In the printing press according to the fifth embodiment, the humidifying devices 91, 92, 93, and 94 are respectively arranged in the upstream side of the printing units 21, 22, 23, and 24 on the conveyor line of the web W in the feeding direction of the web W, and also the dehumidifying devices 95, 96, 97, and 98 are respectively arranged in the downstream side of the printing units 21, 22, 23, and 24 on the conveyor line of the web W in the feeding direction of the web W. Alternatively, at least one humidifying device can be arranged in the most upstream side of the printing units 21, 22, 23, and 24, i.e., between the infeed device 12 and the printing unit 21, and also at least one dehumidifying device can be arranged in the most downstream side of the printing units 21, 22, 23, and 24, i.e., between the printing unit 24 and the drying device 14.

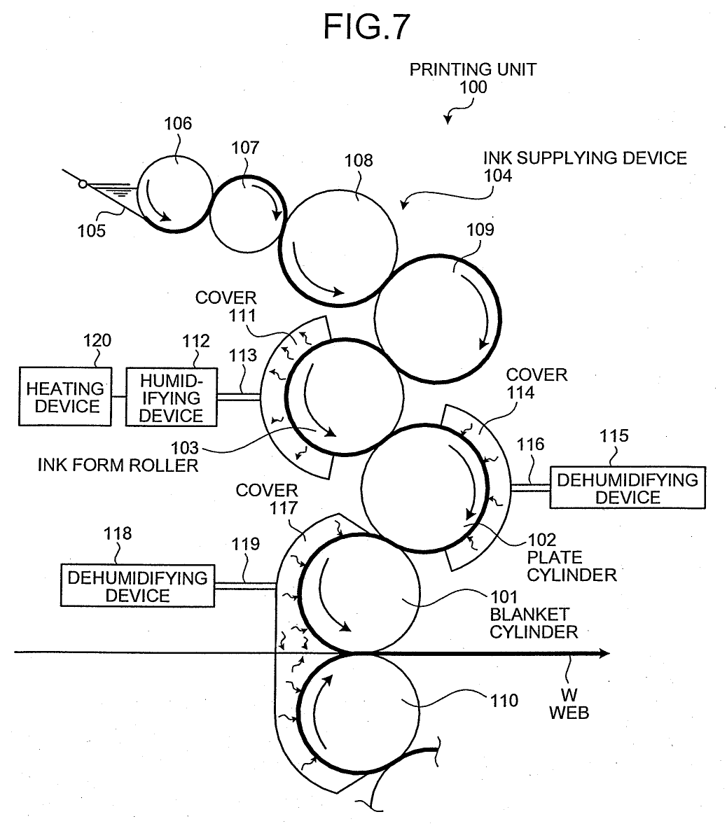

FIG. 7 is a schematic diagram of a printing unit 100 included in a printing press according to a sixth embodiment of the present invention.

The printing press according to the sixth embodiment is a web offset perfecting-printing press using an oil-based ink, and includes the feeder device, the infeed device, the printing device, the drying device, the cooling device, the web passing device, the folding device, and the delivery device in the same manner as that is for the first embodiment. The printing device includes four printing units for cyan, magenta, yellow, and black oil-based inks respectively. The printing units are arranged to be aligned along the feeding direction of the web W.

In the printing press according to the sixth embodiment, as shown in FIG. 7, the printing unit 100 is located above the feeding path of the web W, and includes a blanket cylinder 101, a plate cylinder 102, an ink form roller 103, and an ink supplying device 104. The blanket cylinder 101, the plate cylinder 102, and the ink form roller 103 are rotatably arranged in such a manner that the blanket cylinder 101 and the plate cylinder 102 have contact with each other, and also the plate cylinder 102 and the ink form roller 103 have contact with each other. The ink supplying device 104 is arranged above the ink form roller 103, and includes an ink fountain 105, an ink fountain roller 106, an ink transfer roller 107, an ink kneading roller 108, and an ink oscillating roller 109. Incidentally, a member having a reference numeral 110 is a blanket cylinder for rear-side printing, and the blanket cylinders 101 and 110 are arranged across the web W by having contact with each other.

The printing unit 100 further includes a cover 111 and a humidifying device 112, as a water-content increasing unit for increasing a water content of the oil-based ink on the ink form roller 103. The cover 111 covers a transferred portion of the ink form roller 103 where the oil-based ink is transferred. The humidifying device 112 humidifies a space portion covered by the cover 111. The humidifying device 112 is connected to the cover 111 via a connection path 113. Also, a heating device 120 is connected to the humidifying device 112. Moreover, the printing unit 100 further includes a cover 114 and a dehumidifying device 115, as a first water-content decreasing unit for decreasing a water content of the oil-based ink on the plate cylinder 102. The cover 114 covers a transferred portion of the plate cylinder 102 where the oil-based ink is transferred. The dehumidifying device 115 dehumidifies a space portion covered by the cover 114. The dehumidifying device 115 is connected to the cover 114 via a connection path 116. In addition, the printing unit 100 further includes a cover 117 and a dehumidifying device 118, as a second water-content decreasing unit for decreasing a water content of the oil-based ink on the blanket cylinder 101 and a water content of the web W. The cover 117 covers a transferred portion of the blanket cylinder 101 where the oil-based ink is transferred and a front surface of the web W. The dehumidifying device 118 dehumidifies a space portion covered by the cover 117. The dehumidifying device 118 is connected to the cover 117 via a connection path 119.

When an oil-based ink is supplied from the ink supplying device 104 to the ink form roller 103, a water content of the oil-based ink is controlled to ensure a high transferability (i.e., a high flowability) of the oil-based ink, so that the oil-based ink can be supplied to the ink form roller 103 properly. When the oil-based ink on the ink form roller 103 comes to the space portion covered by the cover 111, a water content of the oil-based ink on the ink form roller 103 increases due to air that is heated by the heating device 120 and humidified by the humidifying device 112, and a temperature of the oil-based ink on the ink form roller 103 also increases. Subsequently, when the oil-based ink on the ink form roller 103 is transferred onto the plate surface of the plate cylinder 102, the water content and the temperature of the oil-based ink on the ink form roller 103 increase, so that a good image-forming performance can be obtained. Therefore, the oil-based ink can be transferred onto the plate surface of the plate cylinder 102 with sharpening its edges.

When the oil-based ink on the plate cylinder 102 comes to the space portion covered by the cover 114, a water content of the oil-based ink on the plate cylinder 102 decreases due to the dehumidification by the dehumidifying device 115. Then, when the oil-based ink on the plate cylinder 102 is transferred onto the blanket cylinder 101, the water content of the oil-based ink on the plate cylinder 102 decreases, so that a high transferability of the oil-based ink can be obtained. Therefore, the oil-based ink can be properly transferred onto a surface of the blanket cylinder 101 as a printing image.

When the oil-based ink on the blanket cylinder 101 comes to the space portion covered by the cover 117, a water content of the oil-based ink on the blanket cylinder 101 further decreases due to the dehumidification by the dehumidifying device 118. On the other hand, when the front surface of the web W fed by the blanket cylinder 101 comes to the space portion covered by the cover 117, a water content of the front surface of the web W decreases due to the dehumidification by the dehumidifying device 118. Then, when the oil-based ink on the blanket cylinder 101 comes onto the web W, the oil-based ink on the blanket cylinder 101 is transferred onto the front surface of the web W as the printing image. At this time, the water content of the oil-based ink on the blanket cylinder 101 and the water content of the front surface of the web W decrease, so that a high transferability of the oil-based ink can be obtained. Therefore, the oil-based ink can be accurately transferred onto the front surface of the web W as the printing image.

In this manner, in the printing press according to the sixth embodiment, the printing unit 100 includes the ink supplying device 104, the ink form roller 103, the plate cylinder 102, and the blanket cylinder 101. The ink supplying device 104 supplies an oil-based ink having a predetermined water content to the ink form roller 103. Upon receiving the oil-based ink from the ink supplying device 104, the ink form roller 103 transfers the received oil-based ink onto the plate cylinder 102 by having contact with the plate cylinder 102. The plate cylinder 102 transfers the oil-based ink onto the blanket cylinder 101 by having contact with t the blanket cylinder 101. The blanket cylinder 101 transfers the oil-based ink onto the web W as a printing image. The printing unit 100 further includes the cover 111 and the humidifying device 112, as the water-content increasing unit for increasing a water content of the oil-based ink on the ink form roller 103. The cover 111 covers the transferred portion of the ink form roller 103 where the oil-based ink is transferred. The humidifying device 112 humidifies the space portion covered by the cover 111.

As described above, the oil-based ink is supplied from the ink supplying device 104 to the ink form roller 103, and the oil-based ink on the ink form roller 103 is transferred onto the plate cylinder 102, and thereby forming a predetermined image of the oil-based ink on the plate cylinder 102. At this time, a water content of the oil-based ink on the ink form roller 103 increases due to the humidification by the humidifying device 112. Therefore, while the oil-based ink is supplied from the ink supplying device 104 to the ink form roller 103, a predetermined water content of the oil-based ink is ensured, so that a high transferability of the oil-based ink can be obtained. Then, while the oil-based ink on the ink form roller 103 is transferred onto the plate cylinder 102, a water content of the oil-based ink on the ink form roller 103 increases, so that a good image-forming performance can be obtained. Consequently, it is possible to improve the printing quality, and also to adjust a water content of the oil-based ink efficiently with a simple configuration.

In addition, in the printing press according to the sixth embodiment, the printing unit 100 further includes the cover 114 and the dehumidifying device 115, as the first water-content decreasing unit for decreasing a water content of the oil-based ink on the plate cylinder 102. The cover 114 covers the transferred portion of the plate cylinder 102 where the oil-based ink is transferred. The dehumidifying device 115 dehumidifies the space portion covered by the cover 114. When the oil-based ink on the ink form roller 103 is transferred onto the plate cylinder 102, after a water content of the oil-based ink on the ink form roller 103 increases due to the humidification by the humidifying device 112. After that, when the oil-based ink on the plate cylinder 102 is transferred onto the blanket cylinder 101, a water content of the oil-based ink on the plate cylinder 102 decreases due to the dehumidification by the dehumidifying device 115, so that a transferability of the oil-based ink can be improved.

Moreover, in the printing press according to the sixth embodiment, the printing unit 100 further includes the cover 117 and the dehumidifying device 118, as the second water-content decreasing unit for decreasing a water content of the oil-based ink on the blanket cylinder 101 and a water content of the front surface of the web W. The cover 117 covers the transferred portion of the blanket cylinder 101 where the oil-based ink is transferred and the front surface of the web W. The dehumidifying device 118 dehumidifies the space portion covered by the cover 117. When the oil-based ink on the ink form roller 103 is transferred onto the plate cylinder 102, a water content of the oil-based ink on the ink form roller 103 increases due to the humidification by the humidifying device 112. Then, when the oil-based ink on the plate cylinder 102 is transferred onto the blanket cylinder 101, a water content of the oil-based ink on the plate cylinder 102 decreases due to the dehumidification by the dehumidifying device 115. After that, when the oil-based ink on the blanket cylinder 101 is transferred onto the web W as a printing image, a water content of the oil-based ink on the blanket cylinder 101 and a water content of the front surface of the web W decrease due to the dehumidification by the dehumidifying device 118, so that a transferability of the oil-based ink can be improved.

A configuration of the printing press using the oil-based ink according to the sixth embodiment is not limited to that is described above. For example, the cover 117 can be separated into two covers, one for the blanket cylinder and the other for the web, in the same manner as the covers 61 and 64 for the second embodiment. It is also possible to provide a suction device for dehumidifying a non-image portion of the plate cylinder where the oil-based ink is not transferred, in the same manner as the suction device 72 for the third embodiment. Furthermore, in the same manner as the fourth embodiment, it is possible to provide a control device and humidity detecting sensors so that the control device can set an optimal humidity in each of the space portions covered by the covers 111, 114, and 117 based on a humidity in a building where the printing press is located, which is detected by the peripheral-portion humidity detecting sensor, and control the humidifying device and the dehumidifying devices so that a humidity in each of the space portions covered by the covers 111, 114, and 117, which is detected by the space-portion humidity detecting sensors, to be adjusted to the optimal humidity.

Furthermore, in the printing press using the oil-based ink according to the sixth embodiment, the heating device 120 is connected to the humidifying device 112, so that the space portion covered by the cover 111 is humidified and heated by the humidifying device 112 and the heating device 120. In this case, a temperature of the oil-based ink on the ink form roller 103 increases due to the heating by the heating device 120, so that a viscous property of the oil-based ink decreases, and thus a high transferability of the oil-based ink can be obtained. Alternatively, it is possible to exclude the heating device 120, and the space portion covered by the cover 111 can be humidified only without being heated. Conversely, it is possible to exclude the humidifying device 112, and the space portion covered by the cover 111 can be heated only without being humidified. In this case, a heater can be used as the heating device 120. Moreover, although an increase of a water content of the oil-based ink is required for obtaining a high transferability, the water content of the oil-based ink can be reduced if the transferability is too high.

In the above embodiments, the covers 51, 54, 57, 61, 64, 111, 114, and 117 have the curved shape, but not limited to the shape. As long as each of the covers can form a space portion capable of covering a surface of the roller or the cylinder, the shape of the covers can be changed.

Furthermore, in the above embodiments, the printing press includes four printing units, but not limited to the number of the printing units. Alternatively, the printing press can be configured to include one or two printing units, or five or more printing units. Then, each of the printing units includes the ink supplying device, the ink form roller, the plate cylinder, and the blanket cylinder, but not limited to the configuration and the number of the rollers and the cylinders, and can be changed arbitrarily. Furthermore, the present invention is not limited to the perfecting printing press or the web offset printing press, and can be applied to a single-side printing press or a sheet-fed offset printing press.

As described above, according to an aspect of the present invention, a water-based ink is supplied from the ink supplying unit to the ink form roller, and the water-based ink on the ink form roller is passed to the plate cylinder, and thereby forming a predetermined image of the water-based ink on the plate cylinder. At this time, the water-content decreasing unit decreases a water content of the water-based ink on the ink form roller. Therefore, while the water-based ink is supplied from the ink supplying unit to the ink form roller, a predetermined water content of the water-based ink is ensured, so that a high transferability of the water-based ink can be obtained. Then, while the water-based ink on the ink form roller is transferred onto the plate cylinder, a water content of the water-based ink on the ink form roller decreases, so that a good image-forming performance can be obtained. Consequently, it is possible to improve a printing quality.

Furthermore, according to another aspect of the present invention, a transferred portion of the ink form roller where the water-based ink is transferred is covered by the cover, and a space portion covered by the cover is dehumidified by the dehumidifying unit, so that a water content of the water-based ink on the ink form roller decreases. Therefore, the water content of the water-based ink can be efficiently adjusted with a simple configuration.

Moreover, according to still another aspect of the present invention, when the water-based ink on the ink form roller is transferred onto the plate cylinder after a water content of the water-based ink on the ink form roller decreases, the water-content increasing unit increases a water content of the water-based ink on the plate cylinder. Therefore, when the water-based ink on the plate cylinder is transferred at the following step, an appropriate water content of the water-based ink can be ensured. Consequently, it is possible to improve the transferability of the water-based ink.

Furthermore, according to still another aspect of the present invention, the water-based ink on the ink form roller is passed to the plate cylinder, the water-based ink on the plate cylinder is transferred onto the blanket cylinder, and the water-based ink on the blanket cylinder is transferred onto printing paper as a printing image. When the water-based ink on the ink form roller is passed to the plate cylinder, a water content of the water-based ink on the ink form roller decreases. Then, when the water-based ink on the plate cylinder is transferred onto the blanket cylinder, the water-content increasing unit increases a water content of the water-based ink on the plate cylinder. Then, when the water-based ink on the blanket cylinder is transferred onto the printing paper as the printing image, the water-content increasing unit increases a water content of the water-based ink on the blanket cylinder, so that an appropriate water content of the water-based ink can be ensured. Consequently, it is possible to improve the transferability of the water-based ink.

Moreover, according to still another aspect of the present invention, when the water-based ink on the plate cylinder is transferred onto the printing paper via the blanket cylinder, the water-content increasing unit increases a water content of the water-based ink on the plate cylinder, a water content of the water-based ink on the blanket cylinder, and a water content of the printing paper. Therefore, when the water-based ink on the blanket cylinder is transferred onto the printing paper, an appropriate water content of the water-based ink can be ensured. Consequently, it is possible to improve the transferability of the water-based ink.

Furthermore, according to still another aspect of the present invention, the transferred portion of the plate cylinder where the water-based ink is transferred, the transferred portion of the blanket cylinder where the water-based ink is transferred, and a portion of the printing paper are covered by the covers, and the space portions covered by the covers are humidified by the humidifying units. Therefore, a water content of the water-based ink in each of the space portions can efficiently increase with a simple configuration.

Moreover, according to still another aspect of the present invention, when the water-based ink on the ink form roller is passed to the plate cylinder, a water content of the water-based ink on the ink form roller decreases, and when the water-based ink on the plate cylinder is transferred at the following step, a surface of the plate cylinder after the water-based ink is transferred is dehumidified by the dehumidifying unit. Therefore, when the water-based ink on the ink form roller is passed to the plate cylinder next, a water content of the water-based ink decreases, so that it is possible to improve the image-forming performance.

Furthermore, according to still another aspect of the present invention, the water-content decreasing unit decreases a water content of the water-based ink on the ink form roller depending on a peripheral humidity around the ink form roller and the plate cylinder. Therefore, a water content of the water-based ink can be properly adjusted depending on a peripheral environment.

Moreover, according to still another aspect of the present invention, the control unit controls humidity in each of the space portions in a feedback manner. Therefore, the water-content decreasing unit can accurately adjust a water content of the water-based ink.

Furthermore, according to still another aspect of the present invention, the printing paper is humidified by the humidifying unit before an image is printed thereon. Therefore, a transferability of the water-based ink on the blanket cylinder onto the printing paper can be improved. Furthermore, the printing paper is dehumidified by the dehumidifying unit after the image is printed thereon. Therefore, a time for drying the water-based ink on the printing paper can be reduced. Consequently, it is possible to reduce an operating cost of the printing press.

Moreover, according to still another aspect of the present invention, an oil-based ink is supplied from the ink supplying unit to the ink form roller, and the oil-based ink on the ink form roller is passed to the plate cylinder, and thereby forming a predetermined image of the oil-based ink on the plate cylinder. At this time, the water-content increasing unit increases a water content of the oil-based ink on the ink form roller. Therefore, while the oil-based ink is supplied from the ink supplying unit to the ink form roller, a predetermined water content of the oil-based ink is ensured, so that a high transferability of the oil-based ink can be obtained. Then, while the oil-based ink on the ink form roller is transferred onto the plate cylinder, a water content of the oil-based ink on the ink form roller increases, so that a good image-forming performance can be obtained. Consequently, it is possible to improve a printing quality.

Furthermore, according to still another aspect of the present invention, a transferred portion of the ink form roller where the oil-based ink is transferred is covered by the cover, and a space portion covered by the cover is dehumidified by the dehumidifying unit, so that a water content of the oil-based ink on the ink form roller increases. Therefore, the water content of the oil-based ink can be efficiently adjusted with a simple configuration.

Moreover, according to still another aspect of the present invention, when the oil-based ink on the ink form roller is transferred onto the plate cylinder after a water content of the oil-based ink on the ink form roller increases, the water-content decreasing unit decreases a water content of the oil-based ink on the plate cylinder. Therefore, when the oil-based ink on the plate cylinder is transferred at the following step, an appropriate water content of the oil-based ink can be ensured. Consequently, it is possible to improve the transferability of the oil-based ink.

Furthermore, according to still another aspect of the present invention, the oil-based ink on the ink form roller is passed to the plate cylinder, the oil-based ink on the plate cylinder is transferred onto the blanket cylinder, and the oil-based ink on the blanket cylinder is transferred onto printing paper as a printing image. When the oil-based ink on the ink form roller is passed to the plate cylinder, a water content of the oil-based ink on the ink form roller increases. Then, when the oil-based ink on the plate cylinder is transferred onto the blanket cylinder, the water-content decreasing unit decreases a water content of the oil-based ink on the plate cylinder. Then, when the oil-based ink on the blanket cylinder is transferred onto the printing paper as the printing image, the water-content decreasing unit decreases a water content of the oil-based ink on the blanket cylinder, so that an appropriate water content of the oil-based ink can be ensured. Consequently, it is possible to improve the transferability of the oil-based ink.

Moreover, according to still another aspect of the present invention, when the oil-based ink on the plate cylinder is transferred onto the printing paper via the blanket cylinder, the water-content decreasing unit decreases a water content of the oil-based ink on the plate cylinder, a water content of the oil-based ink on the blanket cylinder, and a water content of the printing paper. Therefore, when the oil-based ink on the blanket cylinder is transferred onto the printing paper, an appropriate water content of the oil-based ink can be ensured. Consequently, it is possible to improve the transferability of the oil-based ink.

Furthermore, according to still another aspect of the present invention, the transferred portion of the plate cylinder where the oil-based ink is transferred, the transferred portion of the blanket cylinder where the oil-based ink is transferred, and a portion of the printing paper are covered by the covers, and the space portions covered by the covers are dehumidified by the dehumidifying units. Therefore, a water content of the oil-based ink in each of the space portions can efficiently decrease with a simple configuration.

Moreover, according to still another aspect of the present invention, at the passing the water-based ink to the ink form roller, a predetermined water content of the water-based ink is ensured, so that a high transferability of the water-based ink can be obtained. Also, at the transferring the water-based ink on the ink form roller onto the plate cylinder, a water content of the water-based ink increases, so that a good image-forming performance can be obtained. Consequently, it is possible to improve the printing quality.

Furthermore, according to still another aspect of the present invention, at the passing the oil-based ink to the ink form roller, a predetermined water content of the oil-based ink is ensured, so that a high transferability of the oil-based ink can be obtained. Also, at the transferring the oil-based ink on the ink form roller onto the plate cylinder, a water content of the oil-based ink increases, so that a good image-forming performance can be obtained. Consequently, it is possible to improve the printing quality.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printing press comprising:
an ink supplying unit that supplies a water-based ink having a predetermined water content set in advance;
an ink form roller that receives the water-based ink from the ink supplying unit;
a plate cylinder that is in contact with the ink form roller, and receives the water-based ink from the ink form roller; and
a water-content decreasing unit that decreases the water content of the water-based ink on the ink form roller.

2. The printing press according to claim 1, wherein the water-content decreasing unit includes
a cover that covers a transferred portion of the ink form roller where the water-based ink is transferred, and
a first dehumidifying unit that dehumidifies a space portion covered by the cover.

3. The printing press according to claim 1, further comprising a first water-content increasing unit that increases the water content of the water-based ink on the plate cylinder.

4. The printing press according to claim 3, further comprising:
a blanket cylinder that is in contact with the plate cylinder, and transfers the water-based ink supplied on the plate cylinder onto a printing medium as a printing image; and
a second water-content increasing unit that increases the water content of the water-based ink on the blanket cylinder.

5. The printing press according to claim 4, wherein the second water-content increasing unit increases the water content of the printing paper before printing the printing image.

6. The printing press according to claim 3, wherein the first water-content increasing unit includes
a cover that covers a transferred portion of the plate cylinder where the water-based ink is transferred; and
a humidifying unit that humidifies a space portion covered by the cover.

7. The printing press according to claim 4, wherein the second water-content increasing unit includes
a cover that covers a transferred portion of the blanket cylinder where the water-based ink is transferred and a portion of the printing paper; and
a humidifying unit that humidifies a space portion covered by the cover.

8. The printing press according to claim 3, further comprising a dehumidifying unit that dehumidifies a surface of the plate cylinder after the water-based ink is transferred.

9. The printing press according to claim 1, further comprising:
a peripheral humidity detecting unit that detects a peripheral humidity around the ink form roller and the plate cylinder; and
a control unit that controls the water-content decreasing unit based on the peripheral humidity detected by the peripheral humidity detecting unit.

10. The printing press according to claim 9, further comprising a space-portion humidity detecting unit that detects a humidity in a space portion covered by the cover, wherein
the control unit controls the water-content decreasing unit to adjust the humidity in the space portion detected by the space-portion humidity detecting unit to be an optimal humidity that is set based on the peripheral humidity detected by the peripheral humidity detecting unit.

11. The printing press according to claim 1, wherein
a plurality of printing units each including the ink supplying unit, the ink form roller, and the plate cylinder is arranged along a feeding direction of the printing paper,
a humidifying unit that humidifies the printing paper is provided at least on an uppermost stream side of the printing units, and
a dehumidifying unit that dehumidifies the printing paper is provided at least on a lowermost stream side of the printing units.

12. A printing press comprising:
an ink supplying unit that supplies a oil-based ink having a predetermined water content set in advance;
an ink form roller that receives the oil-based ink from the ink supplying unit;
a plate cylinder that is in contact with the ink form roller, and receives the oil-based ink from the ink form roller; and
a water-content increasing unit that increases the water content of the oil-based ink on the ink form roller.

13. The printing press according to claim 12, wherein the water-content increasing unit includes
a cover that covers a transferred portion of the ink form roller where the oil-based ink is transferred, and
a humidifying unit that humidifies a space portion covered by the cover.

14. The printing press according to claim 12, further comprising a first water-content decreasing unit that decreases the water content of the oil-based ink on the plate cylinder.

15. The printing press according to claim 14, further comprising:
a blanket cylinder that is in contact with the plate cylinder, and transfers the oil-based ink supplied on the plate cylinder onto a printing medium as a printing image; and
a second water-content decreasing unit that decreases the water content of the oil-based ink on the blanket cylinder.

16. The printing press according to claim 15, wherein the second water-content decreasing unit decreases the water content of the printing paper before printing the printing image.

17. The printing press according to claim 15, wherein the first water-content decreasing unit includes
a cover that covers a transferred portion of the plate cylinder where the oil-based ink is transferred; and
a dehumidifying unit that dehumidifies a space portion covered by the cover.

18. The printing press according to claim 16, wherein the second water-content decreasing unit includes
a cover that covers a transferred portion of the blanket cylinder where the water-based ink is transferred and a portion of the printing paper; and
a dehumidifying unit that dehumidifies a space portion covered by the cover.

19. A printing method comprising:
supplying a water-based ink having a predetermined water content set in advance to an ink form roller; and
forming an image of the water-based ink by transferring the water-based ink on the ink form roller onto a plate cylinder while decreasing the water content of the water-based ink on the ink form roller.

20. A printing method comprising:
supplying a oil-based ink having a predetermined water content set in advance to an ink form roller; and
forming an image of the oil-based ink by transferring the oil-based ink on the ink form roller onto a plate cylinder while increasing the water content of the oil-based ink on the ink form roller.
